(19) United States
(12) Patent Application Publication
(10) Pub. No.: US 2020/0076213 A1
(43) Pub. Date: Mar. 5, 2020

(54) CHARGING CRADLE

(71) Applicant: BOYER, INC., Houston, TX (US)

(72) Inventor: Ryan PEDERSEN, League City, TX (US)

(21) Appl. No.: 16/553,334

(22) Filed: Aug. 28, 2019

Related U.S. Application Data
(60) Provisional application No. 62/724,168, filed on Aug. 29, 2018.

(51) Int. Cl. H02J 7/00; H02J 7/02

(52) U.S. Cl. CPC H02J 7/0044; H02J 7/025

(57) ABSTRACT

Embodiments described herein generally relate to apparatus for storing and charging a wireless device, such as a controller. A cradle apparatus includes a device cradle and a back plate. In one embodiment, the device cradle is configured to support a wireless device to be charged. In one embodiment, the device cradle includes two or more arm members configured to support a wireless device. The device cradle may also include one or more protection members to protect the wireless device while positioned in the device cradle. A first recess is formed in a surface of the device cradle and a second recess is formed in a surface of the back plate. The first recess and the second recess are substantially aligned. A wireless charger is positioned at least partially in the first recess and at least partially in the second recess.

### CROSS-REFERENCE TO RELATED APPLICATIONS

This application claims benefit of U.S. Provisional Patent Application No. 62/724,168, filed Aug. 29, 2018, the entirety of which is herein incorporated by reference.

### BACKGROUND

### Field

Embodiments disclosed herein generally relate to a charging cradle for a wireless device, and more specifically, an apparatus for holding and charging a wireless device.

### Description of the Related Art

Many devices, especially in industry are controlled remotely. For example, overhead cranes are controlled using a hand-held controller. The hand-held controller is typically connected to the crane via an electrical cable. Using a connected controller poses a risk of injury to the operator because the operator is in close proximity to a load suspended by the crane. Thus, the field of view of the operator is limited by a length of the cable. However, a longer cable creates other hazards for the operator, such as a tripping hazard, and generally increases a chance of an accident occurring.

To move the operator to a safer distance from the load, a wireless controller is used. However, when an operator completes a lift using the crane, the wireless controller is typically set aside to prevent damage. When the crane is needed for a subsequent lift, the wireless controller cannot be found. If the wireless controller is located, it cannot be used because the controller was not charged following the previous lift.

Thus, what is needed in the art is improved apparatus for storing and charging a wireless device.

### SUMMARY

In one embodiment, an apparatus is provided which includes a back plate. A first recess is formed in a first surface of the back plate. A second recess is formed in a second surface of a cradle. The cradle is constructed and arranged to support a device to be charged. The first recess and the second recess are substantially aligned and define a void therein. A charger is positioned in the void for charging the device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a cradle apparatus for storing and charging a wireless controller, according to one embodiment of the disclosure.

FIG. 2A illustrates a rear perspective view of a device cradle according to an embodiment of the disclosure.

FIG. 2B illustrates a schematic rear view of the device cradle according to an embodiment of the disclosure.

FIG. 2C illustrates a schematic side view of the device cradle according to an embodiment of the disclosure.

FIG. 3 illustrates a schematic rear view of a back plate according to an embodiment of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to apparatus for storing and charging a wireless device, such as a controller. A cradle apparatus includes a device cradle and a back plate. In one embodiment, the device cradle is configured to support a wireless device to be charged. In one embodiment, the device cradle includes two or more arm members configured to support a wireless device. The device cradle may also include one or more protection members to protect the wireless device while positioned in the device cradle. A first recess is formed in a surface of the device cradle and a second recess is formed in a surface of the back plate. The first recess and the second recess are substantially aligned. A wireless charger is positioned at least partially in the first recess and at least partially in the second recess.

The charger is configured to charge the wireless device when the wireless device is positioned in the device cradle. In one embodiment, the charger is wholly disposed in the second recess formed in the back plate. In one embodiment, the charger is an inductive charger configured to charge the wireless device while positioned in the device cradle. The wireless charger is connected to a power source to charge the wireless device.

The first recess and the second recess are configured to enclose various chargers therebetween. For example, a charger for a first wireless device may be have a different size or shape than a charger for a second wireless device. However, the first recess and second recess are constructed and arranged such that various chargers can be positioned therein.

In one embodiment, the cradle apparatus is mounted on a substantially planar surface, such as a wall, an electrical box, and the like. The cradle apparatus may be mounted via one or more fasteners, such as one or more screws. In one embodiment, the cradle apparatus may be adhered to the substantially planar surface via a glue or tape, or similar adhesive. The cradle apparatus may be configured to support and charge one or more wireless controllers. Although the cradle apparatus described herein includes two pieces, it is contemplated that the cradle apparatus is fabricated as a unitary apparatus.

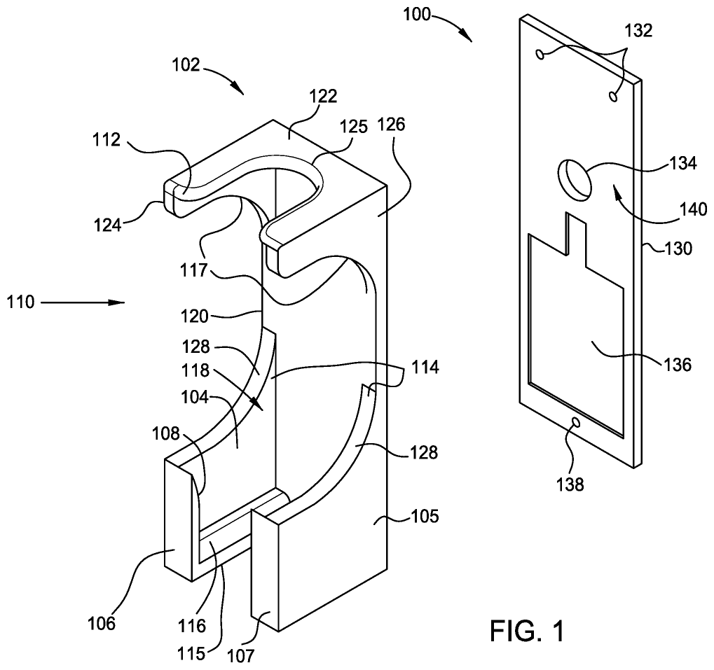

FIG. 1 illustrates a cradle apparatus 100 for storing and charging a wireless device, according to one embodiment of the disclosure. As shown, the cradle apparatus 100 includes a device cradle 102 and a back plate 130. In one embodiment, the device cradle 102 is mounted and used without the back plate 130. In this embodiment, the device cradle 102 is mounted directly to a planar surface. Utilizing the device cradle 102 without the back plate 130 may reduce manufacturing cost and simplify installation of the cradle apparatus 100.

In one embodiment, the device cradle 102 and the back plate 130 are fabricated from a thermoplastic polymer containing material, such as ABS or PLA. In other embodiments, the device cradle 102 and the back plate 130 are fabricated from a metallic material, such as aluminum or stainless steel, or alloys thereof. In one embodiment, the device cradle 102 and the back plate 130 are fabricated from different materials.

In one embodiment, the device cradle 102 includes a body 120, a first arm member 104, a second arm member 105, a first protection member 124 and a second protection member 126. While the device cradle 102 is illustrated having two protection members 124 and 126, it is contemplated that the cradle apparatus 100 be fabricated with one or more protection members. The one or more protection members, such as the first protection member 124 and the second protection member 126, may be a plate fabricated from a similar material as the body 120. The back plate 130 includes a recess 136, a passage 134, and one or more mounting holes 132 and 138. In one embodiment, device cradle 102 is a unitary apparatus fabricated from a single material.

The first arm member 104 extends laterally from and normal to the body 120 of the device cradle 102. The second arm member 105 extends laterally from the body 120 of the device cradle 102 opposite and parallel to the first arm member 104. A base plate 115 extends laterally inward from and is normal to each of the first arm member 104 and the second arm member 105. In one embodiment, an edge 116 of the base plate 115 facing the void 118 is filleted.

A first face plate 106 extends laterally inward from and normal to the first arm member 104. The first face plate 106 is parallel to and opposite the body 120 of the device cradle 102. In one embodiment, a portion 108 of the first face plate 106 opposite the base plate 115 is tapered.

Similarly, a second face plate 107 extends laterally inward from and normal to the second arm member 105. In one embodiment, the second face plate 107 is coplanar with the first face plate 106 of the first arm member 104. The second face plate 107 is parallel to and opposite the body 120. In one embodiment, an end of the second face plate 107 opposite the base plate 115 is tapered.

The body 120, the first arm member 104, the second arm member 105, the base plates 115, the first face plate 106, and the second face plate 107 at least partially define a void 118 therebetween. The void 118 is configured to confine and support a wireless device while the wireless device is charging.

A support member 114 is disposed on each of the first arm member 104 and the second arm member 105. The support members 114 are coplanar with a corresponding arm member 104, 105. The support members 114 extend laterally from and are normal to the body 120 of the device cradle 102. Each of the support members 114 has an arcuate surface 128. The arcuate surfaces 128 extend from the arm members 104, 105 to the body 120 of the device cradle 102.

The first protection member 124 extends laterally from and normal to the body 120 of the device cradle 102. The first protection member 124 is coplanar with and opposite the first arm member 104. The second protection member 126 extends laterally from and is normal to the body 120. The second protection member 126 is parallel to and opposite the first protection member 124. The second protection member 126 is coplanar with and opposite the second arm member 105. Each of the first protection member 124 and the second protection member 126 has an arcuate surface 117. The arcuate surfaces 117 are opposite the arcuate surfaces 128 of the support members 114 to form an opening 110 between the arm members 104, 105 and the protection members 124, 126.

A top plate 122 is disposed on the protection members 124, 126 opposite the arcuate surface 117. In one embodiment, a notch 125 is formed in the top plate 122. In one embodiment, the notch 125 is a semicircular opening in the top plate 122. In one embodiment, an edge 112 of the notch 125 is filleted on a first side of the top plate 122 and a second side of the top plate 122. Thus, the edge 112 of the notch 125 is rounded.

The back plate 130 is substantially planar to enable mounting of the cradle apparatus on a planar surface. For example, the cradle apparatus 100 may be mounted on a wall, an electrical box, or similar surface. The back plate 130 has one or more mounting holes 132, 138 formed therethrough. The device cradle 102 may have one or more mounting holes formed therethrough (not shown in FIG. 1) which correspond to the mounting holes 132, 138 of the back plate 130. The passage 134 is formed through the back plate 130. The passage 134 enables a cable or wire to pass through the back plate 130. The recess 136 is formed in a surface 140 of the back plate 130. The recess 136 is disposed between the passage 134 and the mounting hole 138.

In operation, the surface 140 of the back plate 130 faces the device cradle 102. The back plate 130 mounts to the device cradle 102 via one or more fasteners (not shown) through the mounting holes 132 and 138. The recess 136 is configured to at least partially surround an inductive battery charger (not shown). The inductive battery charger may be used to charge a battery of a wireless device supported and protected by the cradle apparatus 100.

The device cradle 102 is configured to enable a wireless device to be inserted into the opening 110. The wireless device slides into the void 118 along the tapered portion 108 of the first face plate 106 and the tapered portion 108 of the second face plate 107. Once fully inserted into the void 118, the wireless device is supported by the base plates 115. The first protection member 124, the second protection member 126, the first arm member 104, and the second arm member 105 maintain an orientation of the wireless device as the device is inserted into the device cradle 102.

The device cradle 102 mounts to the back plate 130 via one or more fasteners (not shown) through the mounting holes 132 and 138. The cradle apparatus 100 protects the wireless device while it is charging. The device cradle is designed to enable easy insertion and removal of the wireless device as well as protect the wireless device from light impacts. The cradle apparatus provides a storage location for the wireless device to prevent the occurrence of misplacing the wireless device.

In one embodiment, the device cradle 102 and the back plate 130 are snap fit by one or more tabs (not shown) which are inserted into one or more openings (not shown). In one embodiment, the one or more tabs are disposed on the device cradle 102 and the one or more openings are formed through the back plate 130. In another embodiment, the one or more tabs are disposed on the back plate 130 and the one or more openings are formed through the device cradle 102.

In one embodiment, a seal (not shown) is disposed on the surface 140 of the back plate 130. The seal may be disposed along an edge of surface 140 such that the seal is pressed between the back plate 130 and the device cradle 102 when the device cradle 102 is mounted to the back plate 130.

A configuration of the device cradle 102 may be altered depending on the device to be charged. For example, a distance between the body 120 and the face plates 106 and 107 may be adjusted depending on a size of the device to be charged. Further, the top plate 122 may be a solid plate to protect a particular type of device to be charged. While the device cradle 102 is altered for a particular size or type of wireless device, the back plate 130 remains the same. That is, various configurations of the device cradle 102 may be used with a single back plate 130 having a recess 136 formed therein.

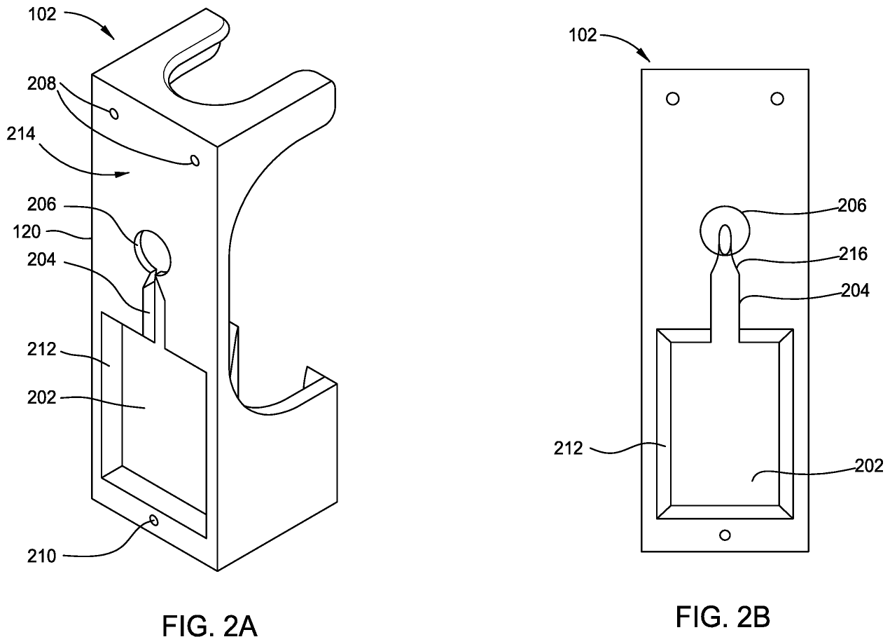

FIG. 2A illustrates a rear perspective view of a device cradle 102 according to an embodiment of the disclosure. A recess 202 is formed in a surface 214 of body 120 the device cradle 102. The recess 202 is substantially the same size as the recess 136 formed in the back plate 130, shown in FIG. 1. In one embodiment, an edge 212 of the recess 202 is chamfered. In operation, the edge 212 of the recess 202 is substantially aligned with an edge of the recess 136 in the back plate 130 when the cradle apparatus 100 is mounted. In one embodiment, where the back plate 130, illustrated in FIG. 1, is not used, the charger (not shown) is wholly disposed in the recess 202 of the device cradle 102.

A wireway 204 and a void 206 are formed in the surface 214 of the body 120. The void 206 and the recess 202 are in fluid communication via the wireway 204. Mounting holes 208 and 210 are formed through the body 120. The mounting holes 208, 210 are substantially aligned with the mounting holes 132, 138, respectively, of the back plate 130, illustrated in FIG. 1, when the cradle apparatus 100 is mounted. One or more fasteners (not shown) pass through the mounting holes 208, 210 of the device cradle 102 and the mounting holes 132, 138 of the back plate 130 to mount the cradle apparatus 100 to a substantially planar surface.

The recess 202 is configured to at least partially surround the inductive charger (not shown) positioned therein. The wireway 204 and void 206 are configured to enable a power cord (not shown) of the charger to be disposed between the device cradle 102 and the back plate 130 when the cradle apparatus 100 is mounted.

FIG. 2B illustrates a schematic rear view of the device cradle 102 according to an embodiment of the disclosure. In one embodiment, the wireway 204 includes a tapered portion 216 adjacent to the void 206. The tapered portion 216 enables the power cord of the inductive charger to be disposed in a center of the wireway 204 as the power cord enters the void 206.

FIG. 2C illustrates a schematic side view of the device cradle 102 according to an embodiment of the disclosure. A length of the first protection member 124 extending from the body 120 is substantially the same as a length of the base plate 115 extending from the body 120. However, as illustrated, the length of the first protection member 124 (and the second protection member 126 shown in FIG. 1) extending from the body 120 is less than the length of the base plate 115 extending from the body 120. The first protection member 124 (and the second protection member 126) is shorter than the base plate 115 to reduce an amount of interference of the first protection member 124 (and the second protection member 126) when the wireless device is inserted into the void 118 along the tapered portion 108 of the face plate 106. Similarly, an end of the first protection member 124 (and the second protection member 126) opposite the body 120 is rounded to reduce the amount of interference of the first protection member 124 (and the second protection member 126) when the wireless device is inserted into the void 118.

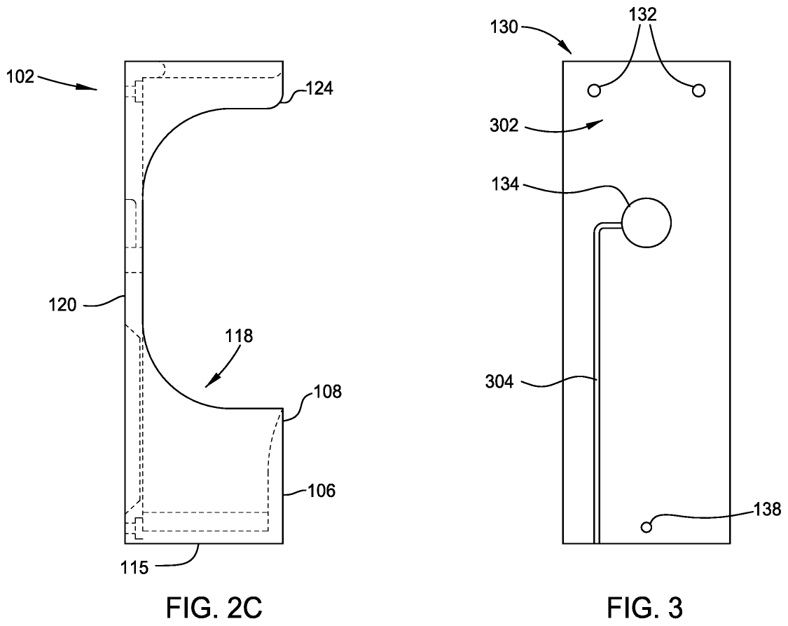

FIG. 3 illustrates a schematic rear view of a back plate 130 according to an embodiment of the disclosure. A channel 304 is formed into a surface 302 of the back plate 130. The power cord of the inductive charger passes through the passage 134 formed through the back plate 130. The power cord of the charger is disposed within the channel 304. Thus, the channel 304 substantially reduces an interference of the power cord when the back plate 130 is mounted on a planar surface. If the back plate 130 is not used with the device cradle 102, a channel, similar to the channel 304, may be formed into the surface 214 of the device cradle 102 discussed with respect to FIGS. 1 and 2.

While the foregoing is directed to embodiments of the present disclosure, other and further embodiments of the disclosure may be devised without departing from the basic scope thereof, and the scope thereof is determined by the claims that follow.

What is claimed is:

1. An apparatus, comprising:
a body having a first side and a second side opposite the first side;
two arm members extending laterally from the first side of the body;
one or more protection members extending laterally from the first side of the body opposite the two arm members; and
an opening formed between the two arm members and the one or more protection members.

2. The apparatus of claim 1, further comprising:
a recess formed in the second side of the body.

3. The apparatus of claim 2, further comprising:
a top plate disposed on the one or more protection members opposite the two arm members; and
a notch formed in the top plate between the one or more protection members, the notch having a filleted edge.

4. The apparatus of claim 2, wherein the one or more protection members include a first arcuate surface and each of the two arm members includes a second arcuate surface opposite the first arcuate surface.

5. The apparatus of claim 4, wherein the opening is at least partially defined by the first arcuate surface and the second arcuate surface.

6. The apparatus of claim 3, further comprising:
a base plate extending laterally inward from each of the two arm members, each of the base plates extending laterally from and substantially normal to the body.

7. The apparatus of claim 6, wherein each of the base plates includes a filleted edge facing the top plate and wherein the base plates form a support surface facing the top plate.

8. An apparatus, comprising:
a body having a first side and a second side opposite the first side;
a recess formed in the second side of the body;
one or more protection members extending laterally from the first side of the body;
a first arm member extending laterally from the first side of the body parallel to the one or more protection members;
a second arm member extending laterally from the first side of the body opposite the first arm member;
a first face plate extending from the first arm member toward the second arm member, the first face plate opposite and substantially parallel to the first side of the body;
a second face plate extending from the second arm member toward the first face plate, the second face plate substantially parallel to the first face plate; and
a first void defined at least partially by the first arm member, the second arm member, the first face plate, and the second face plate.

9. The apparatus of claim 8, further comprising:
a top plate extending laterally from the body;
a first base plate extending laterally from the body adjacent to the first arm member and opposite the top plate; and
a second base plate extending laterally from the body adjacent to the first arm member and opposite the top plate, each of the first base plate and the second base plate defining a support surface and substantially parallel to the top plate.

10. The apparatus of claim 9, wherein the first face plate includes a tapered portion opposite the first base plate and the second face plate includes a tapered portion opposite the second base plate.

11. The apparatus of claim 8, further comprising:
a wireway formed in the second side of the body, the wireway in fluid communication with the first void.

12. The apparatus of claim 8, further comprising:
a back plate having a third side and a fourth side opposite the third side.

13. The apparatus of claim 12, further comprising:
a first plurality of holes formed through the body; and
a second plurality of holes formed through the back plate, the second plurality of holes substantially aligned with the first plurality of holes.

14. The apparatus of claim 13, further comprising:
a second void formed in the third side of the back plate, the second void substantially aligned with the first void.

15. A system for wirelessly charging a device, comprising:
a device cradle having body with a first side and a second side opposite the first side, wherein the second side is substantially planar;
a first recess formed in the second side of the device cradle; and
a wireless charger disposed at least partially in the first recess.

16. The system of claim 15, further comprising:
a back plate having a third side and a fourth side opposite the third side; and
a second recess formed third side of the back plate, the second recess substantially aligned with the first recess, and the wireless charger disposed at least partially in the second recess.

17. The system of claim 15, further comprising:
a support surface extending laterally from the first side of the device cradle, the support surface configured to support a device to be charged by the wireless charger.

18. The system of claim 17, wherein the device cradle comprises:
a first arm member extending laterally from the first side of the body;
a second arm member extending laterally from the first side of the body opposite the first arm member;
a first base plate extending from the body and along the first arm member toward the second arm member; and
a second base plate extending from the body and along the second arm member toward the first base plate, wherein the first base plate and the second base plate are substantially coplanar and substantially perpendicular to a major axis of the body and substantially perpendicular to the first arm member and the second arm member.

19. The system of claim 18, wherein the support surface is disposed between the first arm member and the second arm member, and wherein the support surface is defined at least by the first base plate and the second base plate.

20. The system of claim 18, wherein a void is defined at least by the first arm member, the second arm member, and the support surface.
